(19) United States
(12) Patent Application Publication
(10) Pub. No.: US 2016/0346784 A1
(43) Pub. Date: Dec. 1, 2016

(54) REFINED RICE MILL WITH AUTOMATIC QUANTITATIVE FEED CONTROL

(71) Applicant: RICEATM CO., LTD, TAICHUNG CITY (TW)

(72) Inventor: Chang-Li Huang, TAICHUNG (TW)

(21) Appl. No.: 15/134,486

(22) Filed: Apr. 21, 2016

(30) Foreign Application Priority Data
May 25, 2015 (TW) 104208027

(51) Int. Cl. B02B 3/00

(52) U.S. Cl. CPC B02B 3/00

(57) ABSTRACT

The present invention provides a refined rice mill with automatic quantitative feed control, which comprises a box and a quantity-control feeder and a rice milling unit provided inside the box, and a control module. The quantity-control feeder can supply grain (such as rice grain) quantitatively to the rice milling unit, so that multiple equal quantities of refined rice can be obtained.

### BACKGROUND OF INVENTION

1. Field of the Invention

The present invention relates generally to a rice mill, and more particularly to a refined rice mill that is capable of feeding a preset quantity of grain for refined processing by the rice mill, so as to automatically control the output quantity of refined rice.

2. Description of Related Art

In the case of a prior-art rice mill, to obtain a preset quantity of rice, there are only two solutions: 1, calculate the corresponding quantity of grain based on the expected amount of rice, and feed the corresponding quantity of grain into the rice mill; 2, husk all the grain, and separate the output rice into preset quantities.

Through the first method mentioned above, a preset quantity of rice can be obtained after refined husking. However, in order to obtain multiple equal quantities of rice, the user has to separate the grain into multiple equal quantities in advance. This means some level of trouble. All packed rice sold in the current market is produced by the second method. But this method also requires some time for separating the rice.

Thus, to overcome the aforementioned problems of the prior art, it would be an advancement in the art to provide an improved structure that can significantly improve the efficacy. Therefore, the inventor has provided the present invention of practicability after deliberate design and evaluation based on years of experience in the production, development and design of related products.

### SUMMARY OF THE INVENTION

The main object of the present invention is to provide a refined rice mill with automatic quantitative feed control, which can automatically and quantitatively control the output quantity of refined rice, so as to obtain a preset quantity of rice. It has some practical value indeed.

Hence, to achieve said object, the present invention provides a refined rice mill with automatic quantitative feed control, which comprises a box, with an inlet port provided on the top for feeding grain, a door to open and close, configured on one side of the box, and a rice quantity exit to take out the embryo rice, brown rice or white rice after husking and processing; a quantity-control feeder, provided inside the box and connected to the inlet port, to feed grain of controlled quantity; a rice milling unit, provided inside the box and connected to the quantity-control feeder, and also connected to the rice quantity exit, to husk and refine the grain supplied by the quantity-control feeder and transfer the refined rice to the rice quantity exit; a control module, provided on the door and connected to the rice milling unit and quantity-control feeder, to control operation of the rice milling unit and quantity-control feeder.

Further benefits and advantages of the present invention will become apparent after a careful reading of the detailed description with appropriate reference to the accompanying drawings.

### BRIEF DESCRIPTION OF THE DRAWINGS

FIG. 1 is a front view of one preferred embodiment of the present invention.

FIG. 2 is a schematic view of the components inside the box of one preferred embodiment of the present invention.

FIG. 3 is a schematic view of the box structure of one preferred embodiment of the present invention.

FIG. 4 is a schematic view of the quantity-control feeder of one preferred embodiment of the present invention.

### DETAILED DESCRIPTION OF THE INVENTION

Referring to the accompanying drawings that depict one preferred embodiment of the present invention, the refined rice mill with automatic quantitative feed control comprises a box 10, a quantity-control feeder 20, a rice milling unit 30 and a control module 40.

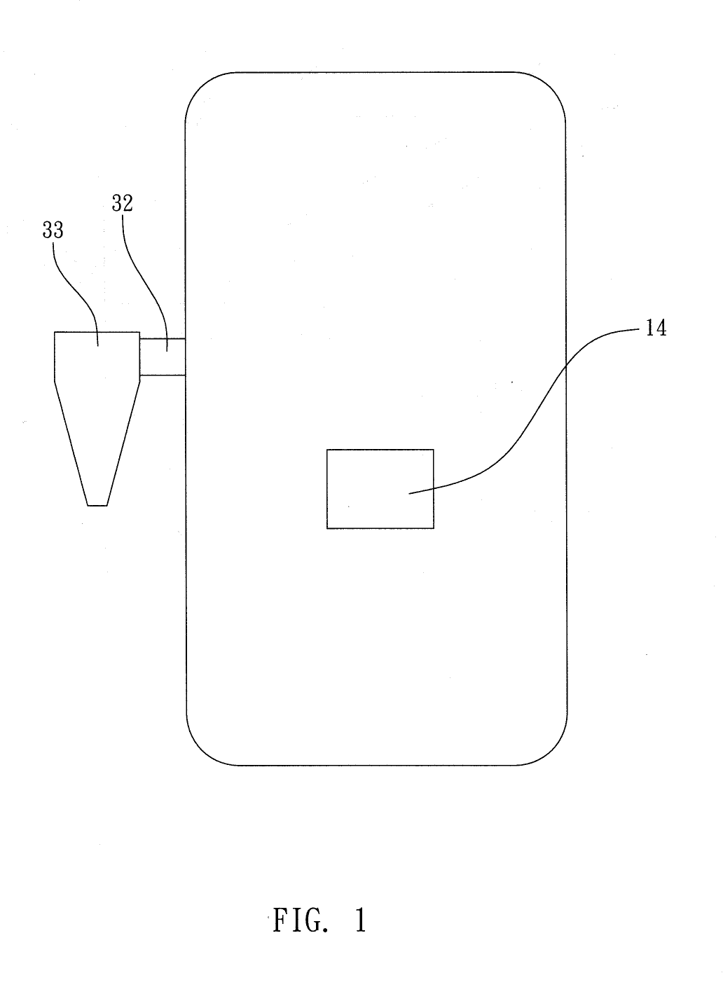

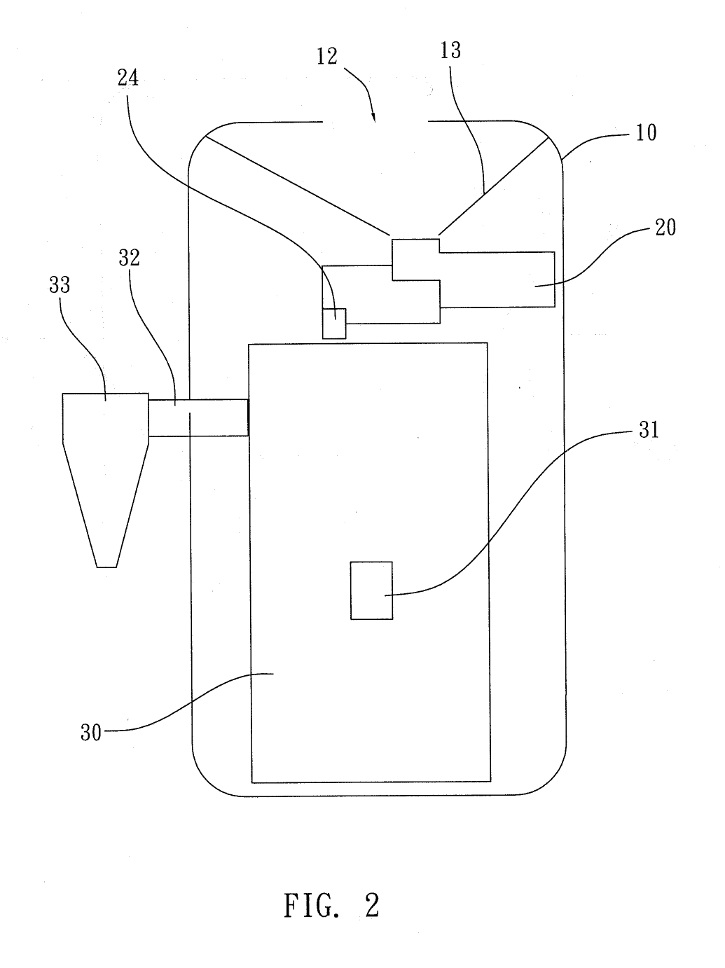

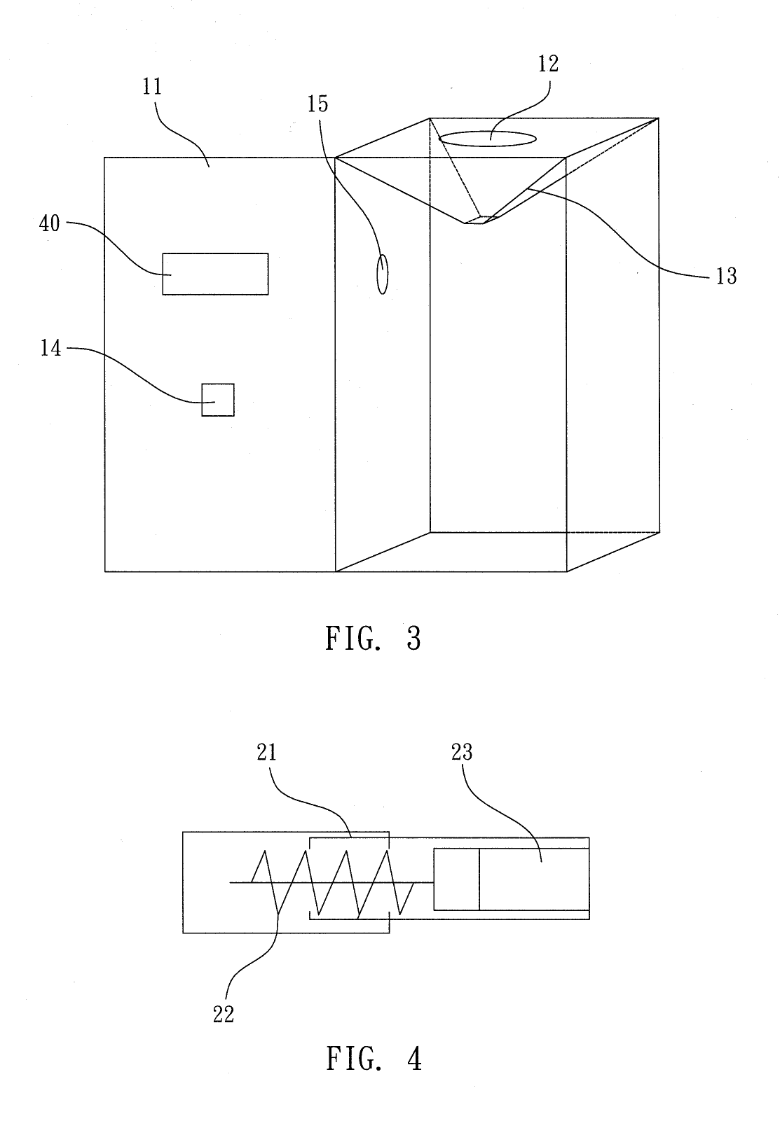

As shown in FIGS. 1 to 3, the box 10 is a closed housing. Its shape is not limited, but a rectangular shape is more practical. Its material is also not limited, but is normally metal to ensure sufficient structural strength and loading capacity. Its front side is configured with a door 11 to open and close. Its top side is configured with an inlet port 12. Under the inlet port 12, a storage hopper 13 is configured. To thoroughly transfer the grain (such as rice grain) from the inlet port 12 to the quantity-control feeder 20 through the output port on its bottom. Its shape is not limited. The door 11 is provided with a rice quantity exit 14 to take out the embryo rice, brown rice or white rice after husking and processing. The lateral side of the box 10 is provided with an air duct port 15.

The quantity-control feeder 20 is provided inside the box 10 and connected to the inlet port 12, to transfer grain quantitatively. It comprises a feed chute 21, corresponding to the storage hopper 13, to receive grain from the storage hopper 13, a spiral fin 22, connected to the power output end of a feeding motor 23 and corresponding to the feed chute 21. When the feeding motor 23 is started, it can drive the spiral fin 22 to rotate and squeeze the grain from the feed chute 21 to the feed throat 24.

The rice milling unit 30 is provided inside the box 10 and connected to the feed throat 24 of the quantity-control feeder 20. Its one end is configured with a rice output port 31 that corresponds to the rice quantity exit 14. The rice milling unit 30 is a prior-art device and therefore its detailed structure is not described herein. It can husk and refine the grain from the feed throat 24 and send out the refined rice from the rice output port 31 to the rice quantity exit 14. The refined rice is output from the rice quantity exit 14.

The control module 40 is configured on the door 11 and connected to the rice milling unit 30 and the feeding motor 23 of the quantity-control feeder 30, to control the operation time of the rice milling unit 30 and feeding motor 23.

In addition, the refined rice mill further comprises an air duct 32, connected to the rice milling unit 30, and a dust-collecting barrel 33, placed on one side of the box 10 and connected to the air duct 32. The dust-collecting barrel 33 is to collect the grain husks (such as rice bran) generated by the rice milling unit 30. The air duct 32 goes through the air duct port 15. Furthermore, the door 11 can be further configured with a control panel (not shown in the drawings), which is electrically connected to the control module 40, so that the user can input the expected quantity of rice through the control panel. The control module 40 can control the rice milling unit 30 and feeding motor 23 to operate for a preset time, so as to obtain a preset quantity of rice.

Thus, when the user designates an expected quantity of rice, the quantity-control feeder 20 can be controlled by the control module 40 to supply the grain from the storage hopper 13 quantitatively to the rice milling unit 30 to be husked into embryo rice, brown rice or white rice. The rice bran generated during the husking process is transferred by the air duct 32 to the dust-collecting barrel 33. The refined rice is output from the rice quantity exit 14. Therefore, the present invention can automatically and quantitatively control the output of rice, meeting requirements for a preset quantity of refined rice. It is truly effective and useful, and has considerable practical value.

What is claimed is:

1. A refined rice mill with automatic quantitative feed control, comprising:
a box, with its top side configured with an inlet port to feed grain;
a door, configured on one side of the box to open and close; one the door, a rice quantity exit is configured to take out the embryo rice, brown rice or white rice after husking and processing;
a quantity-control feeder, provided inside the box and connected to the inlet port, to transfer grain quantitatively;
a rice milling unit, provided inside the box and connected to the quantity-control feeder, and corresponding to the rice quantity exit, to husk and refine the grain transferred from the quantity-control feeder and then transfer the refined rice to the rice quantity exit; and
a control module, configured on the door and connected to the rice milling unit and the quantity-control feeder, to control the operation of the rice milling unit and quantity-control feeder.

2. The structure defined in claim 1, which further comprises a storage hopper, configured inside the box and corresponding to the inlet port, to transfer the grain from the inlet port to the quantity-control feeder.

3. The structure defined in claim 1, which further comprises an air duct, connected to the rice milling unit, a dust-collecting barrel, placed on one side of the box and connected to the air duct; the dust-collecting barrel is to collect the grain husks generated by the rice milling unit.

4. The structure defined in claim 3, wherein an air duct port is provided on one side of the box; the air duct goes through the air duct port.

5. The structure defined in claim 2, wherein one end of the quantity-control feeder is provided with a feed chute to correspond to the storage hopper, and the other end is provided with a feed throat to correspond to the rice milling unit.

6. The structure defined in claim 5, wherein said quantity-control feeder comprises a feeding motor, and a spiral fin, connected to the power output end of the feeding motor in a rotary manner and corresponding to the feed chute, to squeeze the grain quantitatively to the feed throat.

7. The structure defined in claim 1, wherein one end of the rice milling unit is configured with a rice output port to correspond to the rice quantity exit.

8. The structure defined in claim 6, wherein said control module is electrically connected to the rice milling unit and feeding motor.
